(19) United States
(12) Patent Application Publication
(10) Pub. No.: US 2010/0243834 A1
(43) Pub. Date: Sep. 30, 2010

(54) DECORATIVE APPARATUS FOR AN IV POLE AND METHOD FOR USE OF SAME

(75) Inventor: Deric Douglas Salser, Sunnyvale, TX (US)

Correspondence Address: RG & ASSOCIATES, 1103 TWIN CREEKS, STE. 120, ALLEN, TX, 75013, US

(73) Assignee: POLE PALS LLC, Sunnyvale, TX (US)

(21) Appl. No.: 12/726,641

(22) Filed: Mar. 18, 2010

Related U.S. Application Data
(60) Provisional application No. 61/163,722, filed on Mar. 26, 2009.

(51) Int. Cl. F16M 13/02

(52) U.S. Cl. 248/219.4

(57) ABSTRACT

The present invention is directed to an adjustable clamp that is configured to hold a decorative ornament to a substantially cylindrical pole, such as, a hospital IV pole. The adjustable clamp may include a base member to hold the decorative ornament to the adjustable clamp. The adjustable clamp may also include an inverted L-shaped deformable locking member attached to the base member. The adjustable clamp may also include an O-shaped flexible clamping member with a plurality of finite locking step projections and a finger accessible shoulder portion extending away from the circular O-shaped curve of the flexible clamping member. A user should be able to mount the adjustable clamp onto an IV pole and place any decorative apparatus onto the IV pole via the clamping member.

### CROSS-REFERENCE TO RELATED APPLICATIONS

The instant application is a non-provisional of and claims priority from provisional patent application 61/163,722, filed Mar. 26, 2009, entitled DECORATIVE APPARATUS FOR AN IV POLE AND METHOD FOR USE OF SAME, the entire contents of which are incorporated by reference herein.

### TECHNICAL FIELD OF THE INVENTION

This invention relates, in general, to hospitalization and, in particular, to a decorative apparatus for a hospital IV pole and method for use of the same that help an individual, such as a child or loved-one, cope with hospitalization.

### BACKGROUND OF THE INVENTION

Spending time confined to a hospital room can be far from a pleasant experience and bringing some comfort and cheer to the patient, particularly if the patient is a child, is often a priority. Decorating the hospital room is one preferred method of improving the patient's surroundings and making the hospital experience more enjoyable. There is an ongoing need for new hospital decorations that provide comfort and cheer without encumbering the work of nurses or doctors.

### SUMMARY OF THE INVENTION

Example embodiments of the present invention may include an adjustable clamp configured to hold a decorative ornament to a substantially cylindrical pole. The adjustable clamp may include a base member that includes a substantially flat surface to hold the decorative ornament to the adjustable clamp. The adjustable clamp may also include an inverted L-shaped deformable locking member attached to the base member. The adjustable clamp may also include an O-shaped flexible clamping member with a plurality of finite locking step projections and a finger accessible shoulder portion extending away from the circular O-shaped curve of the flexible clamping member. The O-shaped flexible clamping member is secured to the substantially cylindrical pole via a locking force provided by the inverted L-shaped deformable locking member resting against at least one of the locking step projections of the O-shaped flexible clamping member.

Other example embodiments of the present invention may include an adjustable clamp configured to hold a decorative ornament to a substantially cylindrical pole. The adjustable clamp includes holding means for holding the decorative ornament to the adjustable clamp. The adjustable clamp may also include deformable locking means for being deformable and lockable to the base member, and clamping means with a plurality of finite locking step projections and a finger accessible shoulder portion extending away from a circular O-shaped curve of the clamping means. The clamping means is secured to the substantially cylindrical pole via a locking force provided by the deformable locking means resting against at least one of the locking step projections of the O-shaped curve of the clamping means.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 depicts a front elevation view of one embodiment of a decorative apparatus mounted to an IV pole;

FIG. 2 depicts a rear elevation view of the decorative apparatus of FIG. 1;

FIG. 3 depicts a top perspective view of the decorative apparatus of FIG. 1; and

FIGS. 4A & 4B depict front perspective views of an adjustable clamp of the decorative apparatus of FIG. 3 in open and locked positions, respectively.

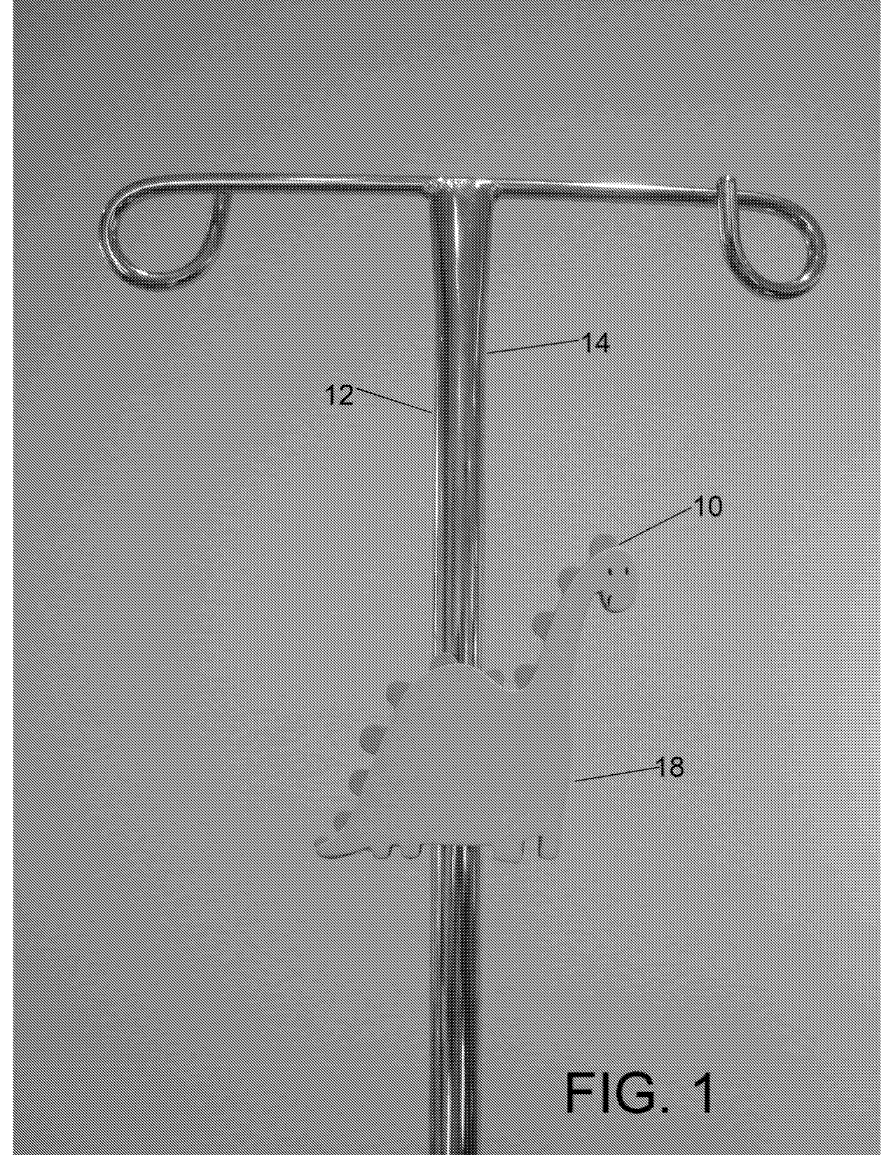

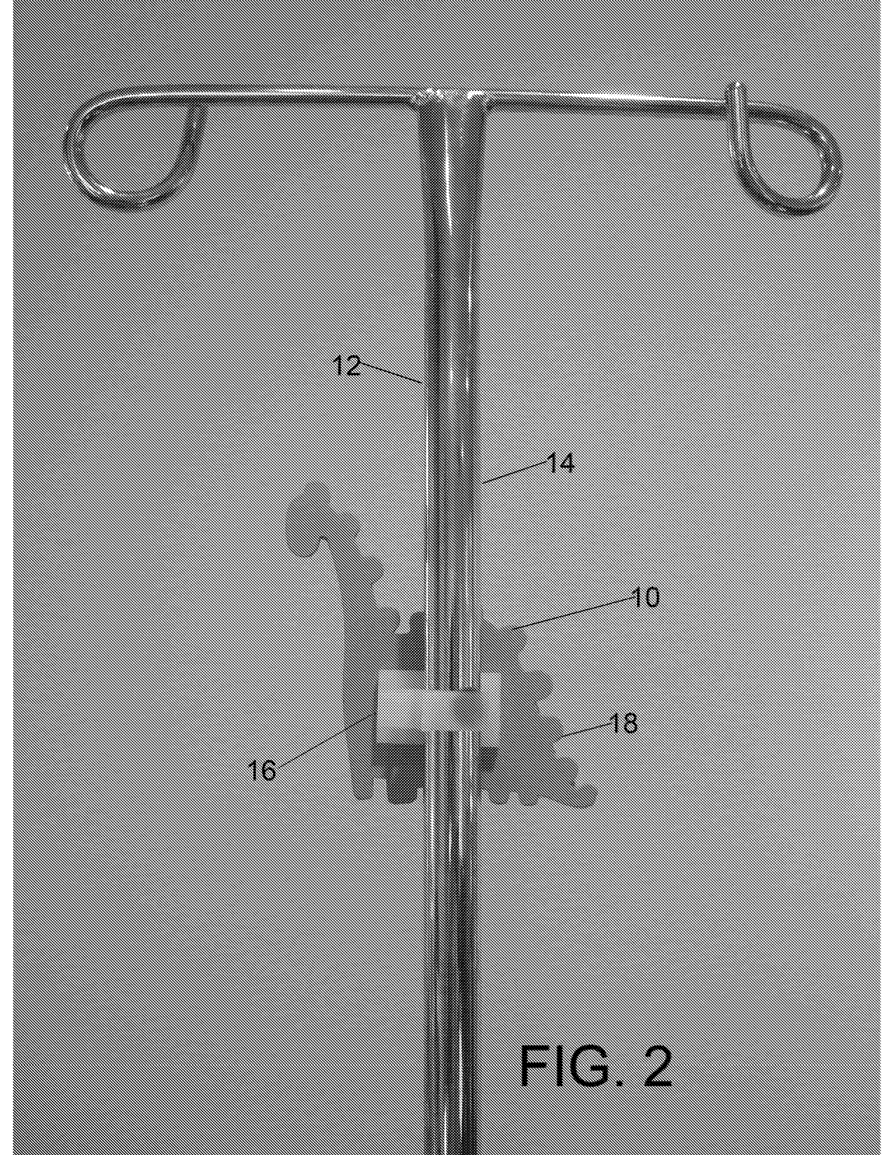

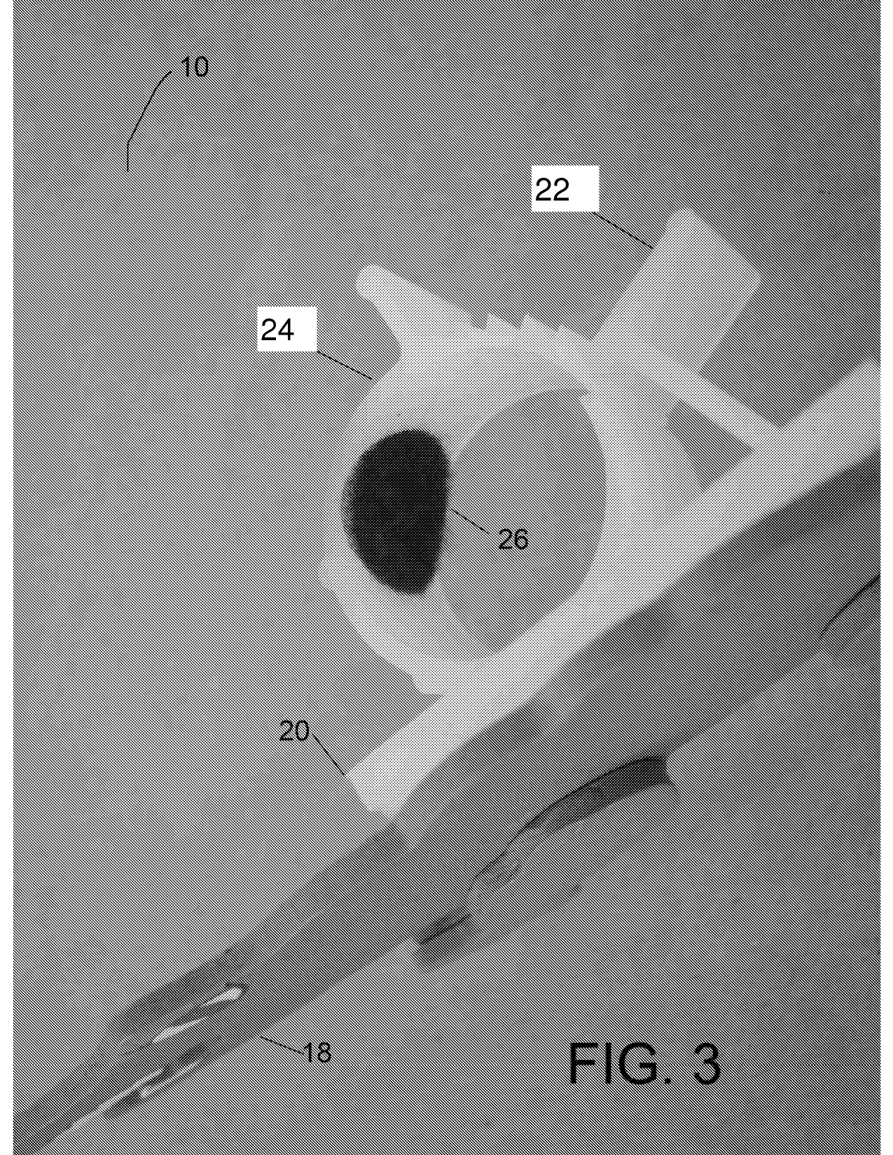

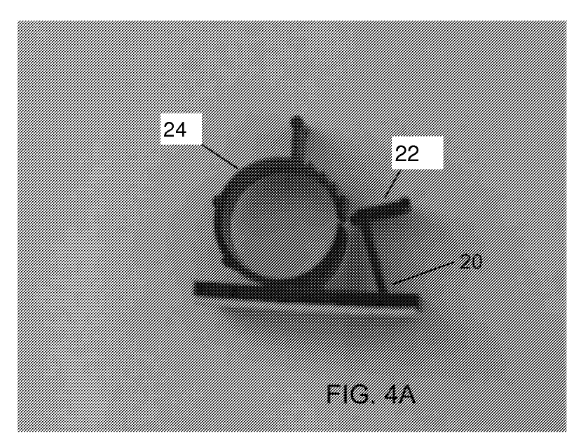

Additionally, a set of photographs of a prototype of the decorative apparatus presented in FIGS. 1-4 are included in Appendix A. The photographs include 43 color images that depict the prototype's construction.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

Referring to FIGS. 1 through 4B, therein is depicted a decorative apparatus that is schematically illustrated and generally designated 10. The decorative apparatus is mounted to an IV pole 12 of the type commonly found in a hospital having a weighted base with casters positioned thereon for contact with the floor. As shown, a vertical section 14 extends from the weighted base to support arms from which standard components, such as an administration bag and tubing, for example, may be hung or supported.

The decorative apparatus 10 includes an adjustable clamp 16 mounted to the vertical section 14 of the IV pole 12 in order to support a decorative or interactive object 18 that may furnish comfort and cheer. By way of example, and not by way of limitation, the decorative or interactive object may include a board, such as a whiteboard or chalkboard, a plaque, a frame or a photograph, artwork, a craft, such as a wooden or plastic animal, or a pouch for holding a stuffed animal, for example. Exemplary photographs of these various embodiments are included in Appendix A.

Returning to FIGS. 1 through 4B, the adjustable clamp 16 includes a base member 20 onto which the decorative or interactive object 18 is mounted. The base member 20 also includes a substantially inverted L-shaped deformable locking member 22 and a substantially O-shaped flexible clamping member 24 disposed thereon on a side opposite of the side providing contact with the decorative or interactive object 18. As will be described in more detail hereinbelow, the adjustable clamp 16 is releasably securable to the vertical section 14 of the IV pole 12 by way of a snap fit engagement provided by the cooperation of the L-shaped deformable locking member 22 and O-shaped flexible clamping member 24.

The inverted L-shaped deformable locking member 22 extends upwardly from a location near one edge of the base member 20 and the O-shaped flexible clamping member 24 is located near a center of the base member 20. In the form selected for illustration, the adjustable clamp 16 is integrally formed as a unit by molding of resilient material. The base member 20 is substantially rigid as at an interface with the base member 20.

The inverted L-shaped deformable locking member 22 includes a free end having a flexible tab with an inclined face positioned thereat. The inverted L-shaped deformable locking member 22 is substantially rigid at an interface with the base member 20 with increased flexibility at distal portions including the flexible tab. The inclined face is disposed at an angle towards the O-shaped flexible clamping member 24 and is biased towards the O-shaped flexible clamping member 24.

The O-shaped flexible clamping member 24 is substantially rigid at an interface of contact with the base member 20. Inner and outer surfaces of the O-shaped flexible clamping member 24 form a continuous body which is broken at a juncture defining two ends; a free end and a rigid end. An arcuate portion defines an integral or living hinge with increased flexibility that permits the rotation of the free end past the rigid end. A shoulder portion extends from a location proximate to the free end to permit a user to drive the free end down toward the base member past the rigid member when securing the decorative apparatus to the vertical section. The outer surface includes a plurality of projections forming a respective number of barbs adapted to catch the inclined face of the flexible tab. The inner surface includes a friction material 26 disposed completely or partially thereon. In one embodiment, the friction material 26 includes a friction facing which faces the interior of the O-shaped flexible clamping member 24 and an adhesive facing which bonds to the interior surface of the O-shaped flexible clamping member. The friction facing of the friction material may include a felt material or web of a paperlike structure which is made basically of fibers other than carbon fibers, such as cellulosic fibers or synthetic fibers or asbestos fibers. It should be appreciated that the O-shaped flexible clamping member 24 is appropriately sized for the vertical section 14 of the IV pole 12. By way of example, the adjustable clamp 16 may be a ¾″ clamp.

The friction material 26 may be a friction inducing material that creates friction preventing movement from the downward force of gravity measured from the position of the adjustable clamp 16 mounted on the IV pole 12. The material may be a type of plastic, felt or other material with some resiliency when pressed against the IV pole 12. The amount of friction material 26 may vary, for example, the interior surface of the O-shaped clamping member 24 may be covered by 25%, 50%, 75% or 100% of the friction material, or, any variation in-between.

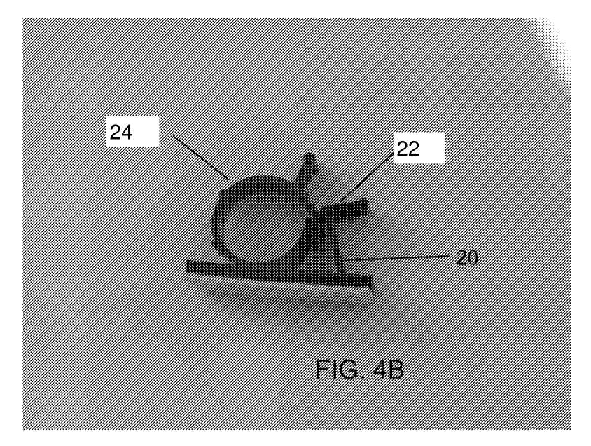

To effect a locking engagement, that is, activating the adjustable clamp from the open position of FIG. 4A to the locked position of FIG. 4B, the inverted L-shaped deformable locking member 22 and O-shaped flexible clamping member 24 are adapted to provide an inter-engaging locking relationship that adjustably and releasably mounts the decorative apparatus 10 to the vertical section 14 of the IV pole 12. Initially, by pressing the shoulder portion of the O-shaped flexible clamping member 24 away from the inverted L-shaped deformable locking member 22, the area within an interior of the inner surface is augmented to permit attachment of the O-shaped flexible clamping member 24 to the vertical section 14 by way of manual manipulation by the desired size of clamp opening being furnished.

With the O-shaped flexible clamping member 24 circumscribing the vertical section 14, the shoulder portion is pressed toward the inverted L-shaped deformable locking member 22. This causes the free end of the O-shaped flexible clamping member 24 to slide between the rigid end of the O-shaped flexible clamping member 24 and the inclined face of the flexible tab. During this action, the inclined surface of the flexible tab slides in a cammed fashion over the plurality of projections. When the point of desired locking engagement has been reached, the inclined face of the flexible tab, which is biased towards the O-shaped flexible clamping member 24, engages one of the plurality of projections along the outer surface. By way of this snap fit engagement, the disengagement of the inverted L-shaped deformable locking member 22 and O-shaped flexible clamping member 24 is prevented.

The friction material 26 furnishes dry friction between the adjustable clamp 16 and vertical section 14 of the IV pole 12 such that relative vertical motion between these two solid surfaces, i.e., the inner surface of the O-shaped flexible clamping member 24 and the vertical section 14 of the IV pole 12, in contact is avoided.

To release the decorative apparatus 10, the flexible tab is pressed towards the base which deflects the inclined face away from the plurality of projections of the O-shaped flexible clamping member 24. The snap fit and lock initially created by the inverted L-shaped deformable locking member 22 is thereby released. By pressing the shoulder portion of the O-shaped flexible clamping member 24 away from the inverted L-shaped deformable locking member 22, the area within the interior of the inner surface is augmented to permit removal of the O-shaped flexible clamping member 24 from the vertical section 14 by way of manual manipulation. The decorative apparatus 10 is thereby removed from the IV pole 12.

In another application, the decorative apparatus 10 is coupled to the IV pole 12 by a compression fit. In some instances, the IV pole 12 may have a diameter that meets or exceeds the opening provided by the adjustable clamp 16. For example, the IV pole 12 may have a diameter of 1⅛″. In these instances, the O-shaped flexible clamping member 24 may be fully opened and secured to the vertical section 14 of the IV pole 12 by way of a compression fit wherein the L-shaped deformable locking member 22 is not engaged by the O-shaped flexible clamping member 24. In this implementation, the friction material 26 furnishes dry friction between the adjustable clamp 16 and vertical section 14 of the IV pole 12 such that relative vertical motion is avoided as previously discussed.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that this disclosure encompass any such modifications or embodiments.

What is claimed is:

1. An adjustable clamp configured to hold a decorative ornament to a substantially cylindrical pole, the adjustable clamp comprising:
a base member comprising a substantially flat surface to hold the decorative ornament to the adjustable clamp;
an inverted L-shaped deformable locking member attached to the base member; and
an O-shaped flexible clamping member with a plurality of finite locking step projections and a finger accessible shoulder portion extending away from the circular O-shaped curve of the flexible clamping member,
wherein the O-shaped flexible clamping member is secured to the substantially cylindrical pole via a locking force provided by the inverted L-shaped deformable locking member resting against at least one of the locking step projections of the O-shaped flexible clamping member.

2. The adjustable clamp of claim 1, further comprising:
a friction inducing material attached to interior surface of the O-shaped flexible clamping member providing a friction inducer when the O-shaped flexible clamping member is affixed to the pole.

3. The adjustable clamp of claim 2, wherein the friction inducing material is different from the material of the O-shaped flexible clamping member.

4. The adjustable clamp of claim 2, wherein the friction inducing material is composed of felt material and is different from the material of the O-shaped flexible clamping member.

5. The adjustable clamp of claim 2, wherein the friction inducing material is composed of plastic material and is different from the material of the O-shaped flexible clamping member.

6. The adjustable clamp of claim 2, wherein the friction inducing material occupies approximately 25% of the surface area of the interior surface of the O-shaped flexible clamping member.

7. The adjustable clamp of claim 2, wherein the friction inducing material occupies approximately 50% of the surface area of the interior surface of the O-shaped flexible clamping member.

8. The adjustable clamp of claim 2, wherein the friction inducing material occupies approximately 75% of the surface area of the interior surface of the O-shaped flexible clamping member.

9. The adjustable clamp of claim 2, wherein the friction inducing material occupies approximately 100% of the surface area of the interior surface of the O-shaped flexible clamping member.

10. The adjustable clamp of claim 1, wherein the O-shaped flexible clamping member is attached to the base member.

11. The adjustable clamp of claim 1, wherein the base member, the O-shaped flexible clamping member, and the inverted L-shaped deformable locking member are composed of the same material.

12. An adjustable clamp configured to hold a decorative ornament to a substantially cylindrical pole, the adjustable clamp comprising:
holding means for holding the decorative ornament to the adjustable clamp;
deformable locking means for being deformable and lockable to the base member; and
clamping means with a plurality of finite locking step projections and a finger accessible shoulder portion extending away from a circular O-shaped curve of the clamping means,
wherein the clamping means is secured to the substantially cylindrical pole via a locking force provided by the deformable locking means resting against at least one of the locking step projections of the O-shaped curve of the clamping means.

13. The adjustable clamp of claim 12, further comprising:
a friction inducing means attached to an interior surface of the clamping means providing a friction inducer when the clamping means is affixed to the pole.

14. The adjustable clamp of claim 13, wherein the friction inducing means is a different material from the material of the clamping means.

15. The adjustable clamp of claim 13, wherein the friction inducing means is composed of felt material and is different from the material of the clamping means.

16. The adjustable clamp of claim 13, wherein the friction inducing means is composed of plastic material and is different from the material of the clamping means.

17. The adjustable clamp of claim 13, wherein the friction inducing means occupies approximately 25% of the surface area of the interior surface of the clamping means.

18. The adjustable clamp of claim 13, wherein the friction inducing means occupies approximately 50% of the surface area of the interior surface of the clamping means.

19. The adjustable clamp of claim 13, wherein the friction inducing means occupies approximately 75% of the surface area of the interior surface of the clamping means.

20. The adjustable clamp of claim 13, wherein the friction inducing means occupies approximately 100% of the surface area of the interior surface of the clamping means.
